(19) United States
(12) Patent Application Publication
(10) Pub. No.: US 2003/0230817 A1
(43) Pub. Date: Dec. 18, 2003

(54) Mold for UV curable adhesive and method of use therefor

(75) Inventor: Russell A. Crook, Hellertown, PA (US)

Correspondence Address: HITT GAINES P.C., P.O. BOX 832570, RICHARDSON, TX, 75083, US

(73) Assignee: Agere Systems, Inc., Allentown, PA

(21) Appl. No.: 10/170,976

(22) Filed: Jun. 13, 2002

(51) Int. Cl. B29D 11/00; B29C 35/08

(52) U.S. Cl. 264/1.38; 264/496; 264/338; 425/449; 425/174.4

(57) ABSTRACT

A mold and a method of using a mold for forming a UV-cured article, the mold including a UV-transparent body having formed therein a mold cavity and an inlet, the inlet extending from an exterior surface of the UV-transparent body to the mold cavity. The mold cavity is configured to contain a UV-curable material, and the inlet is configured to supply UV-curable material to the mold cavity.

### TECHNICAL FIELD OF THE INVENTION

The present invention is directed, in general, to molds for forming three-dimensional articles and, more specifically, to a mold for forming a UV-cured article, and a method of use therefor.

### BACKGROUND OF THE INVENTION

Fiberoptic technology continues to grow in importance and abundance, especially in the telecommunications industry. For example, the telecommunications industry employs fiberoptic technology for many uses, including data transmission and signal switching. Such uses conventionally employ fiberoptic assemblies having a number of fibers and optical components coupled to one another, wherein an optical signal may propagate along the transmissive cores centrally located within the fibers and optical components. However, connecting the fibers and optical components to one another to manufacture the fiberoptic assemblies has proven to be a difficult problem.

Conventional fiberoptic systems employ an epoxy or other adhesive between the parallel faces of adjoining fibers or components. However, by placing the epoxy in the optical path of the assembly, the risk of attenuating or otherwise disturbing the optical signal is unavoidable. Additionally, as the efficiency of modern optical systems continues to improve, the power of the optical signals propagating therethrough also increases. Unfortunately, this increased power may degrade the epoxy at the junctions between components, which may ultimately lead to system failure.

Further, it comes as no surprise that the fibers and optical components continue to decrease in size, making the coupling more and more difficult. Thus, it is also becoming increasingly difficult to grasp and secure the fibers and optical components to be assembled, and it is also extremely difficult to visually inspect progress during the subsequent application of adhesive or other coupling means.

Accordingly, what is needed in the art is a device and method that overcomes the disadvantages of the prior art in the assembly of fibers and optical components to one another in a fiberoptic assembly.

### SUMMARY OF THE INVENTION

To address the above-discussed deficiencies of the prior art, the present invention provides a mold and a method of using a mold for forming a UV-cured article, the mold including a UV-transparent body having formed therein a mold cavity and an inlet, the inlet extending from an exterior surface of the UV-transparent body to the mold cavity. The mold cavity is configured to contain a UV-curable material, and the inlet is configured to supply UV-curable material to the mold cavity.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description when read with the accompanying FIGUREs. It is emphasized that, in accordance with the standard practice in the industry, various features are not drawn to scale. In fact, the dimensions of the various features may be arbitrarily increased or reduced for clarity of discussion. Reference is now made to the following descriptions taken in conjunction with the accompanying drawings, in which:

FIG. 1 illustrates an end view of one embodiment of a mold constructed according to the principles of the present invention;

FIG. 2 illustrates a section view of another embodiment of a mold constructed according to the principles of the present invention;

FIG. 3 illustrates an elevation view of a fiberoptic assembly manufactured using the mold shown in FIG. 2; and

FIG. 4 illustrates a flowchart depicting a method of manufacturing a three-dimensional article according to the principles of the present invention.

### DETAILED DESCRIPTION

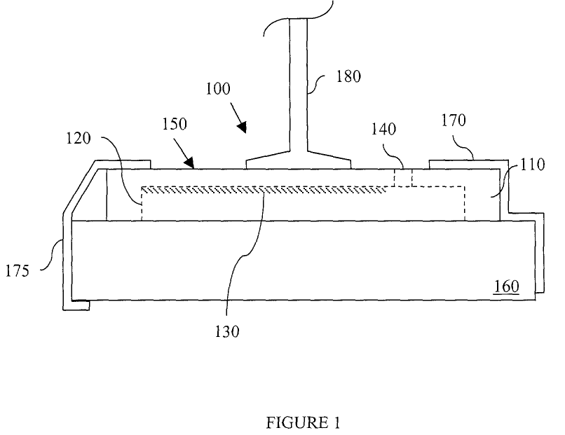

Referring initially to FIG. 1, illustrated is an end view of a mold 100 constructed according to the principles of the present invention. The mold 100 includes a UV-transparent body 110. In referring to the body 110 as UV-transparent, it is intended that ultra-violet (UV) radiation may pass through the body 110 without substantial diminution in power. Such UV radiation may, therefore, provide sufficient power to cure any UV-curable material (not shown) contained within the UV-transparent body 110. Accordingly, the UV-transparent body 110 may comprise an aliphatic and/or polymeric material. For instance, the UV-transparent body 110 may comprise siloxane, hydrocarbon, flourocarbon, acrylate, methacrylate, epoxy functionalized siloxane, or acrylate functionalized siloxane. In one embodiment, the UV-transparent body 110 may comprise material having a surface energy less than about 25 mJ/m². However, the present invention is not limited to use of such materials. The UV-transparent body 110 may also be translucent or, alternatively, include portions that are translucent. It is intended that the term “translucent” includes varying degrees of opaqueness, including substantially transparent.

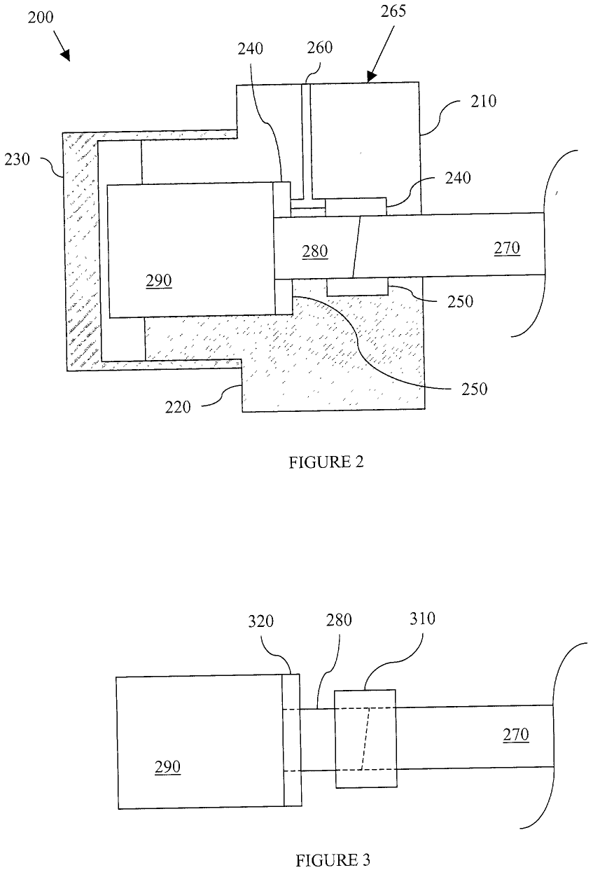

In the illustrative embodiment shown, the UV-transparent body 110 includes a mold cavity 120 (shown in FIG. 1 by hidden lines) configured to contain a UV-curable material. In one embodiment, the mold cavity 120 may substantially conform to a shape of an element employed in fiberoptic systems, such as a gradient index lens (GRIN), a mounting sleeve (ferrule) and/or an end or length of a fiber, as described below with reference to FIG. 2.

In one embodiment, the mold cavity 120 may have a mold release material 130 deposited or otherwise formed on at least a portion of a surface thereof. The mold release material may include siloxanes, polytetrafluoraethylene, hydrocarbons and/or fluorinated hydrocarbons. An example of mold release material is Frekote® 4368, manufactured by Loctite®, located in Rocky Hill, Conn. In one embodiment, the mold release material 130 may substantially cover the surface of the mold cavity 120.

The UV-transparent body 110 may also include an inlet 140 (shown in FIG. 1 by hidden lines) extending from an exterior surface 150 of the UV-transparent body 110 to the mold cavity 120. The inlet 140 is configured to supply UV-curable material to the mold cavity 120.

In the illustrative embodiment shown in FIG. 1, the mold 100 is removably coupled to a substrate 160. The substrate 160 may be a built-up substrate, such as that conventionally used in semiconductor device fabrication. In one embodiment, the substrate 160 may be a wafer, such as that conventionally used in semiconductor and MEMS manufacturing. However, one having skill in the art understands that the substrate 160 may be any structure or device adapted to cooperate or engage with the mold 100 to contain UV-curable material in the mold cavity 120.

The mold 100 may be removably coupled to the substrate 160 by various means, including, but not limited to, by adhesive tape 170 or by a mechanical clip 175 of course, other means for removably coupling the mold 100 to the substrate 160 are within the scope of the present invention. In one embodiment, the mold 100 may be permanently couplable to the substrate 160, rather than removably couplable. The mold 100 may also be positioned and held in place by conventional pick-and-place apparatus. In such pick-and-place embodiments, as well as other embodiments, the structure interfacing with the mold 100, such as that schematically represented by member 180, may also be UV-transparent.

Turning to FIG. 2, illustrated is a section view of a mold 200 constructed according to the principles of the present invention. The mold 200 may comprise a UV-transparent body that includes one or more portions, wherein at least one portion includes UV-transparent material, as discussed above with regard to FIG. 1. In the illustrative embodiment shown in FIG. 2, however, the mold 200 includes a first portion 210 and a second portion 220. The second portion 220 may be removably couplable to the first portion 210, such as by adhesive or mechanical clamps or fasteners. An exemplary clamp 230 is shown.

As shown in FIG. 2, the first portion 210 may have a first cavity 240 formed therein, and the second portion 220 may have a second cavity 250 formed therein. The coupling of the second portion 220 to the first portion 210 defines a mold cavity adapted to contain UV-curable material. In one embodiment, the first and second portions 210, 220 may have multiple cavities 240, 250 formed therein, such that the coupling of the two portions 210, 220 defines multiple mold cavities.

The mold 200 also includes an inlet 260 that extends from an exterior surface 265 of one of the UV-transparent body portions 210, 220 to the mold cavity defined by the cavities 240, 250. The inlet 260 may be used to supply UV-curable material to the mold cavity defined by the cavities 240, 250. The UV-curable material may have a viscosity ranging between about 100 cps and about 200,000 cps at room temperature, depending on the end use requirements (e.g., high viscosity to reduce resin from flowing into the fiber ferrule/GRIN gap). In an advantageous embodiment, the UV-curable material may have a viscosity ranging between about 60,000 cps and 80,000 cps at room temperature. In one embodiment, the inlet 260 may be used to inject UV-curable adhesive into the mold cavity.

As shown in the illustrative embodiment of FIG. 2, the mold 200 may be used to bond fiberoptic components to one another. For instance, a mold cavity defined by the cavities 240 and 250 may be adapted to form an injection mold of an annulus of UV-curable adhesive around an end joint between an optical fiber 270 and a gradient index lens (GRIN) 280. Another mold cavity defined by the cavities 240 and 250 may be adapted to form an injection mold of an annulus of UV-curable adhesive around a butt joint between the GRIN 280 and a mounting sleeve 290. The resulting fiberoptic assembly is shown in FIG. 3, wherein an adhesive annulus 310 surrounds the joint between the fiber 270 and the GRIN 280, and another adhesive annulus 320 surrounds the joint between the GRIN 280 and the mounting sleeve 290. In this manner, fiberoptic components may be joined without requiring or permitting adhesive in between the components. Of course, one of ordinary skill in the art understands that these exemplary uses of the mold 200 are not limiting examples, and that the mold 200 may be used in myriad other applications within and beyond the arena of fiberoptic assembly.

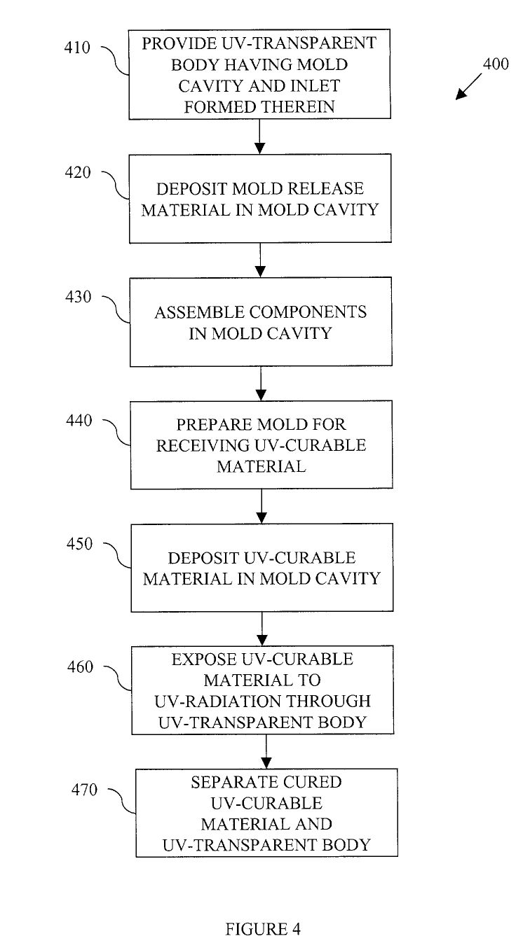

Turning to FIG. 4, illustrated is a flowchart depicting a method 400 of manufacturing a three-dimensional article according to the principles of the present invention. The method 400 begins with a step 410, wherein a UV-transparent body is provided. As discussed above in reference to FIGS. 1 and 2, the UV-transparent body has formed therein a mold cavity for containing a UV-curable material and an inlet for supplying a UV-curable material to the mold cavity. The UV-transparent body may comprise multiple portions, and may contain multiple cavities.

The method 400 may continue at a step 450, wherein a UV-curable material is deposited in the mold cavity or cavities located in the mold. In one embodiment, the UV-curable material may be an adhesive. An example of UV-curable material is Optocast 3410 epoxy manufactured by Electronic Materials, Inc., having a principal place of business in Breckenridge, Colo.

The method 400 may conclude at a step 460, wherein the UV-curable material is exposed to UV radiation through the UV-transparent body. In one embodiment, such exposure may include exposing the UV-curable material to about 270 J/cm² of UV light of course, such exposure may be performed at other energy levels, including from about 90 J/cm² up to about 270 J/cm².

The step 460 may also include irradiating the UV-curable material with a pulsating signal. Such a pulsating signal may have a UV radiation level ranging between about 1000 mw/cm² and infinity. In one embodiment, the pulsating signal may have a UV radiation signal ranging between about 2000 mW/cm² and about 20,000 mW/cm². In an advantageous embodiment, the pulsating signal may have a UV radiation level ranging between about 3000 mW/cm² and about 6000 mW/cm². It should be noted that such a pulsating signal may have a frequency between about 0.03 Hz and about 20 Hz. Those skilled in the art understand the motivation for pulsating the signal. For example, it is known that the signal may be pulsated to dissipate heat energy, as well as minimize residual stresses in the adhesive bond that may originate from differences in the coefficient of thermal expansion between the substrates.

The method 400 may include various other steps in addition to those described above. For instance, the method 400 may include a step 420, wherein a mold release material is deposited or otherwise formed on all or a portion of a surface of the mold cavity formed in the UV-transparent mold. Step 420 may be particularly advantageous in embodiments employing an especially complex or intricate mold cavity. However, in some embodiments, the UV-transparent mold provided in the step 410 may be provided with mold release material already covering all or a portion of a surface of the mold cavity. In such embodiments, the step 420 may not be executed.

The method 400 may also include a step 430, wherein one or more components may be assembled in the mold cavity or cavities prior to filling the cavities with the UV-curable material. For instance, as discussed above with regard to FIGS. 2 and 3, several components of a fiberoptic assembly may be assembled into the mold in the step 430. The fiberoptic components may, for example, be a GRIN lens, a fiberoptic fiber, a fiber mounting sleeve or ferrule, or other similar components.

In one embodiment, the method 400 may also include a step 440, wherein the UV-transparent body provided in the step 410 comprises multiple portions. In such an embodiment, the step 440 may include coupling the multiple portions of the UV-transparent body to one another, thereby defining one or more mold cavities located therein. Such coupling may be accomplished via mechanical fasteners, adhesives, or other conventional means, and may be removable or permanent.

The method 400 may also include a step 470, wherein the UV-transparent body provided in the step 410 is removed from around the cured UV-curable material deposited in the step 450. Alternatively, the step 470 may include removing the cured UV-curable material deposited in the step 450 from within the UV-transparent body provided in the step 410. However, the step 470 is an optional step, such that the method 400 may not include separating the cured UV-curable material from the UV-transparent body.

Although the present invention has been described in detail, those skilled in the art should understand that they can make various changes, substitutions and alterations herein without departing from the spirit and scope of the invention in its broadest form.

What is claimed is:

1. A mold for forming a UV-cured article, comprising:
a UV-transparent body having a mold cavity formed therein, wherein said mold cavity is configured to contain a UV-curable material; and
an inlet extending from an exterior surface of said UV-transparent body to said mold cavity, said inlet supplying said UV-curable material to said mold cavity.

2. The mold as recited in claim 1, wherein said UV-transparent body comprises a first portion and a second portion removably couplable to said first portion to define said mold cavity, and wherein at least one of said first and second portions comprises UV-transparent material.

3. The mold as recited in claim 2, further comprising a fastener removably coupling said first portion to said second portion.

4. The mold as recited in claim 1, wherein said mold cavity substantially conforms to a shape of an element selected from the group consisting of:
a gradient index lens;
a mounting sleeve or ferrule; and
an optical fiber.

5. The mold as recited in claim 1, further comprising a mold release material located on a surface of said mold cavity.

6. The mold as recited in claim 1, wherein at least a portion of said UV-transparent body is translucent.

7. The mold as recited in claim 1, wherein said UV-transparent material comprises an aliphatic material.

8. The mold as recited in claim 1, wherein said UV-transparent material has a surface energy less than about 25 mJ/m².

9. The mold as recited in claim 1, wherein said UV-transparent material comprises a polymeric material selected from the group consisting of:
siloxane;
hydrocarbon; and
flourocarbon.

10. A method of forming a UV-cured article, comprising:
providing a UV-transparent body having formed therein a mold cavity for containing a UV-curable material and an inlet for supplying said UV-curable material to said mold cavity;
placing UV-curable material in said mold cavity; and
exposing said UV-curable material to UV radiation through said UV-transparent body to form a UV-cured article.

11. The method as recited in claim 10, wherein said providing includes providing a UV-transparent body having a first portion and a second portion removably couplable to said first portion.

12. The method as recited in claim 10, wherein said placing said UV-curable material includes injecting said UV-curable material.

13. The method as recited in claim 10, further comprising forming a mold release material on a surface of said mold cavity.

14. The method as recited in claim 13, wherein said mold release material is selected from the group consisting of:
siloxane;
hydrocarbon;
polytetrafluoraethylene; and
fluorinated hydrocarbon.

15. The method as recited in claim 10, wherein said providing includes providing a UV-transparent body comprising an aliphatic material.

16. The method as recited in claim 10, wherein said placing said UV-curable material includes placing a UV-curable material having a viscosity ranging between about 100 cps and about 200,000 cps at about room temperature.

17. The method as recited in claim 10, wherein said placing said UV-curable material includes placing a UV-curable adhesive.

18. The method as recited in claim 10, wherein said exposing includes exposing said UV-curable material to at least about 270 J of UV light.

19. The method as recited in claim 10, wherein said exposing includes irradiating said UV-curable material with a UV radiation signal between about 2000 mW/cm² and about 20,000 mW/cm².

20. The method as recited in claim 19, wherein said UV radiation signal is a pulsating signal having a frequency between about 0.03 Hz and about 20 Hz.
